(19) United States
(12) Patent Application Publication
(10) Pub. No.: US 2024/0106044 A1
(43) Pub. Date: Mar. 28, 2024

(54) Pouch Type Secondary Battery, and Device and Method for Sealing the Same

(71) Applicant: LG Energy Solution, Ltd., Seoul (KR)

(72) Inventor: Ki Beom Park, Daejeon (KR)

(73) Assignee: LG Energy Solution, Ltd., Seoul (KR)

(21) Appl. No.: 18/266,985

(22) PCT Filed: Sep. 27, 2022
(86) PCT No.: PCT/KR2022/014480

§ 371 Date: Jun. 13, 2023

(30) Foreign Application Priority Data
Sep. 28, 2021 (KR) 10-2021-0128364
Sep. 23, 2022 (KR) 10-2022-0121202

(51) Int. Cl. H01M 50/186; H01M 50/105; H01M 50/46

(52) U.S. Cl. CPC H01M 50/186; H01M 50/105; H01M 50/461

(57) ABSTRACT

A secondary battery according to the present invention includes an electrode assembly, in which an electrode and a separator are alternately stacked, and a pouch in which the electrode assembly is accommodated and of which a portion includes a sealing part that is a bonded portion. The sealing part may include a first sealing area, which is spaced a predetermined distance from the electrode assembly and disposed at an edge of the pouch, and a second sealing area that is an area corresponding to the electrode assembly. The present invention also includes a device for sealing the secondary battery and a method for forming same.

### CROSS-REFERENCE TO RELATED APPLICATION

The present application is a national phase entry under 35 U.S.C. § 371 of International Application No. PCT/KR2022/014480 filed on Sep. 27, 2022, which claims the benefit of the priority of Korean Patent Application Nos. 10-2021-0128364, filed on Sep. 28, 2021, and 10-2022-0121202, filed on Sep. 23, 2022, which are hereby incorporated by reference in their entireties.

### TECHNICAL FIELD

The present disclosure relates to a pouch type secondary battery, and a device and method for sealing the pouch type secondary battery, and more particularly, to a sealing device and a sealing method, which improve adhesion between an electrode and a separator provided in a secondary battery so as to prevent an overvoltage or rapid consumption of an electrolyte that may occur according to a bonded state of the electrode and the separator, and a pouch type secondary battery to which the sealing device and the sealing method are applied.

### BACKGROUND ART

Recently, as fossil fuels get exhausted gradually, the interest of alternative energy that can replace the fossil fuels increases in that amounts of the fuels are limited and the importance of environmental pollution prevention increases. Accordingly, research and development for power generation technologies based on energy sources such as solar heat, water power, wind power, ocean energy, and biomass energy, which have little impact on the environmental pollution, are actively carried out.

In particular, research on secondary batteries that can be repeatedly charged are actively carried out, and development is carried out continuously on various aspects such as the materials, efficiency, and structures of the secondary batteries.

In the structural aspects, the secondary batteries are mainly classified into a cylindrical type battery, a prismatic type battery, or a pouch type battery. Accordingly, research and development are carried out to improve energy efficiency and energy density or prevent energy inefficiency according to the structural feature corresponding to each of various types of secondary batteries.

In the aspects of energy efficiency and density, the pouch type battery is more advantageous than other types of batteries, but continuous improvement is attempted in the aspects such as arrangement, combination, or sealing of components, so as to secure higher efficiency.

### DISCLOSURE OF THE INVENTION

### Technical Problem

The pouch type battery has a shape in which an electrode assembly is accommodated in a pouch type case, and the electrode assembly in which an electrode and a separator are alternately stacked is accommodated in the case so that high energy density may be secured. However, in order to maintain the high energy density, the electrode and the separator need to be well bonded to each other, and in order to secure high adhesion, high precision is required during a manufacture process of a secondary battery.

During the manufacture process of the secondary battery, however, when sealing is performed only on an exterior material portion of the pouch type case, there are problems that ends of the electrode and the separator may be poorly bonded to each other to cause an overvoltage or accelerate consumption of an electrolyte. In addition, when an additional sealing process is carried out to bond the ends of the electrode and the separator to each other, a longer manufacture time may be taken or a separate sealing tool may be required, which may lead to inefficiency of the manufacture process.

An object of the present invention devised to solve the problems as above is to provide a secondary battery having high adhesion density by sealing a plurality of regions of a pouch type case without additional manufacture process.

### Technical Solution

A secondary battery according to the present invention may include an electrode assembly, in which an electrode and a separator are alternately stacked, and a pouch in which the electrode assembly is accommodated and of which a portion includes a sealing part that is a bonded portion. The sealing part may include a first sealing area, which is spaced a predetermined distance from the electrode assembly and disposed at an edge of the pouch, and a second sealing area that is a region corresponding to the electrode assembly.

The second sealing area may be a region corresponding to an edge of the electrode assembly, and the edge of the electrode assembly may correspond to an end of the electrode and an end of the separator.

The first sealing area may be a region corresponding to a bonding region at the edge of the pouch, and the second sealing area may be a region corresponding to bonding regions at an end of the electrode and an end of the separator.

Adhesion between an end of the electrode and an end of the separator, which correspond to the electrode assembly, may be greater than adhesion between a portion other than the end of the electrode and a portion other than the end of the separator.

Adhesion of the second sealing area may correspond to adhesion of the first sealing area.

The second sealing area may have an area value that is 7% to 14% of an area value of the pouch when viewed from an upper side.

The first sealing area and the second sealing area may be regions bonded and sealed by heat and pressure.

An area of the second sealing area may be greater than an area of the first sealing area.

The second sealing area may include a region overlapping the electrode assembly when viewed from an upper side.

A device for sealing a secondary battery according to the present invention may include a jig, on which a pouch in which an electrode assembly is accommodated is disposed, and a sealing tool that seals a first sealing area disposed at an edge of the pouch, and a second sealing area disposed in a region corresponding to the electrode assembly of the pouch. The sealing tool performs the sealing of the first sealing area and the second sealing area by heat and pressure.

The sealing tool may include an upper block and a lower block. The upper block may include a first upper block and a second upper block, and the lower block may include a first lower block and a second lower block. The first upper block of the upper block and the first lower block of the lower block may be disposed in regions corresponding to each other, and the first upper block and the first lower block may perform the sealing of the first sealing area.

The second upper block of the upper block and the second lower block of the lower block may be disposed in regions corresponding to each other, and the second upper block and the second lower block may perform the sealing of the second sealing area while pressing a portion of the electrode assembly.

In the sealing tool, the first upper block and the second upper block may be provided as an integrated shape.

A method for sealing a secondary battery according to the present invention may include: a disposing process of disposing, on a jig, the secondary battery including a pouch in which an electrode assembly is accommodated; and a sealing process of sealing a first sealing area disposed at an edge of the pouch disposed on the jig, and a second sealing area corresponding to the electrode assembly of the pouch, by using a sealing tool.

The sealing process may further include a sealing process performed so that adhesion between an end of the electrode and an end of the separator, which correspond to the electrode assembly, is greater than adhesion between a portion other than the end of the electrode and a portion other than the end of the separator.

The sealing process may further include a sealing process performed so that adhesion of the second sealing area corresponds to adhesion of the first sealing area.

The sealing process may further include sealing the first sealing area and the second sealing area at the same time by using the sealing tool.

### Advantageous Effects

The pouch type secondary battery according to the present invention and the device and method for sealing the pouch type secondary battery may provide the secondary battery having the high adhesion density by sealing the plurality of regions of the pouch type case without the additional manufacture process.

The pouch type secondary battery according to the present invention, and the device and method for sealing the pouch type secondary battery may improve the adhesion not only to the exterior material of the pouch type case but also to the end of the electrode and the end of the separator of the electrode assembly, so that the occurrence of the overvoltage or the acceleration of the electrolyte consumption may be prevented.

### BRIEF DESCRIPTION OF THE DRAWINGS

FIG. 1 is a perspective view illustrating a battery cell of a pouch type secondary battery according to an embodiment of the present invention.

FIG. 2 is an exploded perspective view illustrating the battery cell of the pouch type secondary battery according to an embodiment of the present invention.

FIG. 3 is a flowchart illustrating a process of manufacturing a battery cell of a pouch type secondary battery according to an embodiment of the present invention.

FIG. 4 is a perspective view illustrating a process of sealing a battery cell of a pouch type secondary battery according to an embodiment of the present invention.

FIG. 5 is a cross-sectional view illustrating a process of sealing a battery cell of a pouch type secondary battery according to an embodiment of the present invention.

FIG. 6 is a top view illustrating a plurality of sealing areas of a battery cell of a pouch type secondary battery according to an embodiment of the present invention.

### MODE FOR CARRYING OUT THE INVENTION

Hereinafter, preferred embodiments of the present invention will be described in detail with reference to the accompanying drawings so as to enable those skilled in the art to which the present invention pertains to easily carry out the present invention. The present invention may, however, be embodied in different forms and should not be construed as limited by the embodiments set forth herein.

The parts unrelated to the description, or the detailed descriptions of related well-known art that may unnecessarily obscure subject matters of the present invention, will be ruled out in order to clearly describe the present invention. In the drawings, like reference numerals refer to like elements throughout the whole specification.

Moreover, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe his or her invention in the best ways.

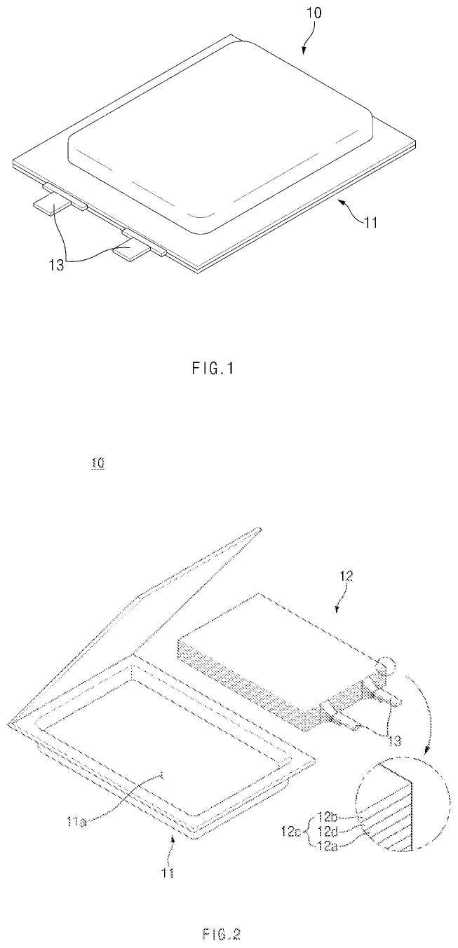

FIG. 1 is a perspective view of a battery cell of a pouch type secondary battery according to an embodiment of the present invention. FIG. 2 is an exploded perspective view of the battery cell of the pouch type secondary battery according to an embodiment of the present invention.

Hereinafter, the configuration of a battery cell 10 of the pouch type secondary battery will be described with reference to FIGS. 1 and 2.

The battery cell 10 may include an electrode assembly 12, and a pouch 11 in which an accommodation part 11a capable of accommodating an electrolyte and the electrode assembly 12 is disposed.

The pouch 11 may have a part to be attached (or bonded) to form a sealing part. The sealing part may include a plurality of sealing areas.

The electrode assembly 12 may be a chargeable and dischargeable device and have a structure in which an electrode 12c and a separator 12d are gathered to be alternately stacked.

The electrode 12c may include a positive electrode 12a and a negative electrode 12b. The electrode assembly 12 may have a structure in which the positive electrode 12a, the separator 12d, and the negative electrode 12b are gathered to be alternately stacked.

The positive electrode 12a may include a positive electrode collector and a positive electrode active material applied to the positive electrode collector, and the negative electrode 12b may include a negative electrode collector and a negative electrode active material applied to the negative electrode collector.

The positive electrode collector may be made of, for example, a foil made of an aluminum (Al) material.

The positive electrode active material may include a lithium manganese oxide, a lithium cobalt oxide, a lithium nickel oxide, a lithium iron phosphate, or a compound or mixture including at least one thereof.

The positive electrode active material may include, for another example, a Hi Ni-based positive electrode material. The Hi Ni-based positive electrode material may include one or more of a LiNiMnCoO-based material, a LiNiCoAl-based material, and a LiMiMnCoAl-based material. Here, the content of nickel (Ni) may be, for example, 0.5 mol to 0.95 mol.

The negative electrode collector may be made of, for example, a foil made of a copper (Cu) or nickel (Ni) material.

In one example, the negative electrode active material may include a material including synthetic graphite. In another example, the negative electrode active material may include a lithium metal, a lithium alloy, carbon, petroleum coke, activated carbon, graphite, a silicon compound, a tin compound, a titanium compound, or an alloy thereof.

The separator 12d is made of an insulation material and thus, electrically insulates the positive electrode 12a and the negative electrode 12b from each other. The separator 12d may be made of, for example, a microporous polyolefin-based resin film such as polyethylene or polypropylene.

The battery cell 10 may include an electrode lead 13 electrically connected to the electrode 12c of the electrode assembly 12.

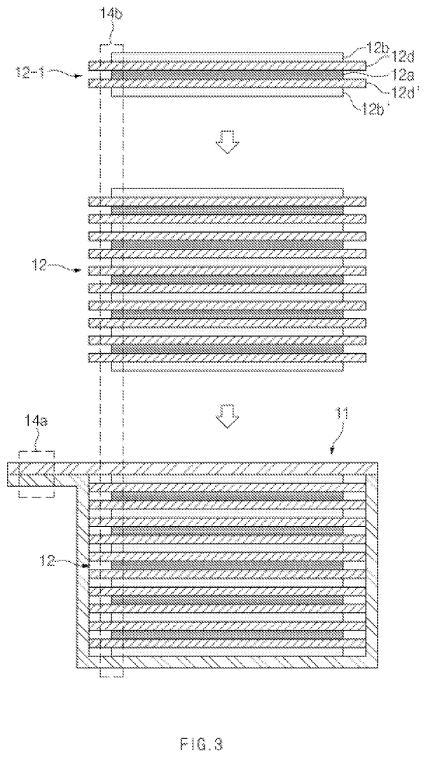

FIG. 3 illustrates a process of manufacturing a battery cell of a pouch type secondary battery according to an embodiment of the present invention.

An electrode assembly unit 12-1 may have a structure in which a negative electrode 12b, a separator 12d, a positive electrode 12a, a separator 12d′, and a negative electrode 12b′ are alternately stacked. Alternatively, the electrode assembly unit 12-1 may have a structure in which a positive electrode, a separator, a negative electrode, a separator, and a positive electrode are alternately stacked.

An electrode assembly 12 may have a structure in which the electrode assembly unit 12-1 is repeatedly stacked. For example, a plurality of electrode assembly units 12-1 may be stacked to form the electrode assembly 12.

The electrode assembly 12 may be accommodated in an accommodation part 11a of a pouch 11. In the accommodation part 11a, an electrolyte may be accommodated in a remaining space except for a space in which the electrode assembly 12 is accommodated.

The pouch 11 may have an edge at which a first sealing area 14a is disposed. The first sealing area 14a may be disposed in a region spaced a predetermined distance from the electrode assembly 12. An exterior material of the pouch 11 may be bonded to itself in the first sealing area 14a so as to maintain a state in which a battery cell 10 is sealed (or airtight). The bonding (or sealing) of the exterior material of the pouch 11 in the first sealing area 14a may be carried out through a method such as thermal fusion by heat and pressure.

A second sealing area 14b may be a region corresponding to the electrode assembly 12. For example, the second sealing area 14b may be a region corresponding to an edge of the electrode assembly 12. The second sealing area 14b may be a region corresponding to an end of the electrode 12c and an end of the separator 12d. In other words, the second sealing area 14b may include a region overlapping the electrode assembly 12 when the battery cell 10 is viewed from an upper side.

The end of the electrode 12c and the end of the separator 12d may be bonded (sealed) to each other in the second sealing area 14b. The bonding (or sealing) of the end of the electrode 12c to the end of the separator 12d may be carried out through a method such as thermal fusion by heat and pressure.

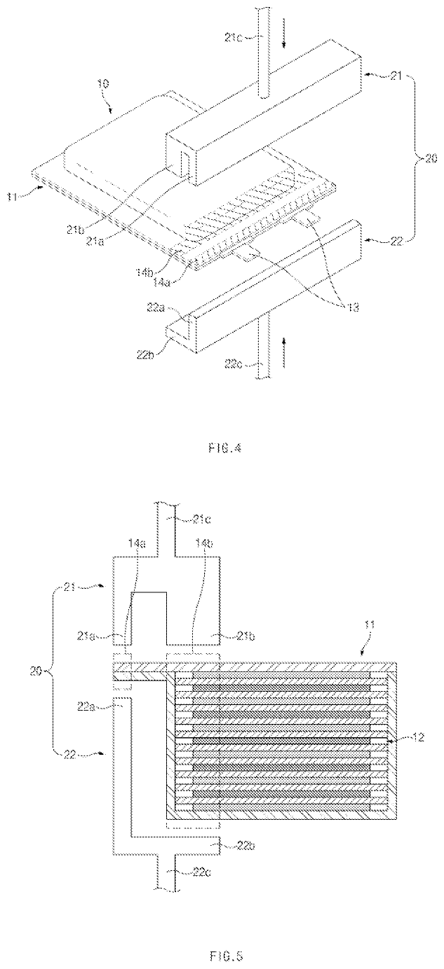

FIG. 4 illustrates a process of sealing a battery cell of a pouch type secondary battery according to an embodiment of the present invention.

A sealing device may include a jig on which a sealing target is disposed, and a sealing tool 20 that seals the sealing target.

The sealing tool 20 may seal a portion of each of the pouch 11 and the electrode assembly 12 of the battery cell 10 by heat and pressure. For example, the sealing tool 20 may press the portion of the pouch 11 in a heated state. In this case, the portion of the electrode assembly 12 may also be pressed.

The battery cell 10 may be sealed through the sealing tool 20 of the sealing device.

A sealing part 14 of the battery cell 10 may include the first sealing area 14a disposed at the edge of the pouch 11, and the second sealing area 14b disposed in the region corresponding to the edge of the electrode assembly 12 accommodated in the pouch 11.

The first sealing area 14a and the second sealing area 14b of the sealing part 14 of the battery cell 10 may be sealed through the sealing tool 20.

The sealing device may include a jig on which the battery cell 10 may be disposed. Alternatively, the sealing device may include a jig on which the pouch 11 in which the electrode assembly 12 is accommodated may be disposed.

The sealing tool 20 may include an upper sealing tool 21 and a lower sealing tool 22. Each of the upper sealing tool 21 and the lower sealing tool 22 may be included in the sealing tool 20 as a separate component, or the upper sealing tool 21 and the lower sealing tool 22 may be integrally formed to be included in the sealing tool 20.

The upper sealing tool 21 may include a first upper block 21a and a second upper block 21b. Each of the first upper block 21a and the second upper block 21b may be included in the upper sealing tool 21 as a separate component, or the first upper block 21a and the second upper block 21b may be integrally formed to be included in the upper sealing tool 21.

The lower sealing tool 22 may include a first lower block 22a and a second lower block 22b. Each of the first lower block 22a and the second lower block 22b may be included in the lower sealing tool 22 as a separate component, or the first lower block 22a and the second lower block 22b may be integrally formed to be included in the lower sealing tool 22.

The sealing tool 20 may include an upper elevation means 21c and a lower elevation means 22c. The upper sealing tool 21 may ascend/descend through the upper elevation means 21c, and the lower sealing tool 22 may ascend/descend through the lower elevation means 22c.

The first upper block 21a and the first lower block 22a may be disposed in regions corresponding to each other. The second upper block 21b and the second lower block 22b may be disposed in regions corresponding to each other.

The first upper block 21a and the first lower block 22a may perform sealing of the first sealing area 14a disposed at the edge of the pouch 11. The second upper block 21b and the second lower block 22b may perform sealing of the second sealing area 14b that is a region corresponding to the electrode assembly 12 (or the edge of the electrode assembly 12). The second upper block 21b and the second lower block 22b may carry out the sealing of the second sealing area 14b while pressing a portion of the electrode assembly 12.

The second sealing area 14b may include a region overlapping the electrode assembly 12 when viewed from an upper side. The second sealing area 14b may have an area value that is 7% to 14% of an area value of the pouch 11 when viewed from an upper side. When the sealing is performed so that the second sealing area 14b has the area ratio relative to the area of the pouch 11 as described above, the adhesion to be described later may be improved to effectively prevent an occurrence of an overvoltage or acceleration of electrolyte consumption.

The sealing of the first sealing area 14a and the second sealing area 14b may be performed at the same time by the sealing tool 20, and the adhesion not only to the edge of the pouch 11 but also between the ends of the electrode 12c and the separator 12d may be improved. Accordingly, the occurrence of the overvoltage in the electrode assembly 12 or the acceleration of the consumption of the electrolyte in the pouch 11 may be prevented.

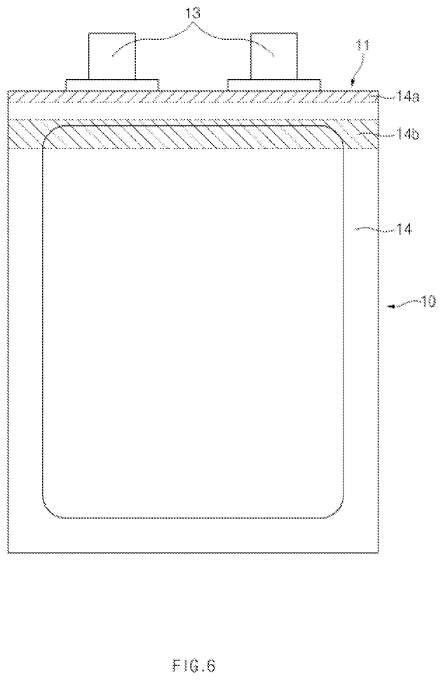

FIG. 5 illustrates a process of sealing a battery cell of a pouch type secondary battery according to an embodiment of the present invention.

The battery cell 10 including the pouch 11 in which the electrode assembly 12 is accommodated may be disposed on the jig of the sealing device so as to be sealed.

The first sealing area 14a disposed on the edge of the pouch 11 may be compressed (or bonded) by heat and pressure through the first upper block 21a and the first lower block 22a so as be sealed.

The second sealing area 14b that is an area corresponding to the edge of the electrode assembly 12 in the pouch 11 may be compressed (or bonded) by heat and pressure through the second upper block 21b and the second lower block 22b so as be sealed.

The sealing may be performed by heat and pressure through the sealing tool so that the adhesion between the end of the electrode 12c and the end of the separator 12d, which correspond to the edge of the electrode assembly 12, may be greater than adhesion between a portion other than the end of the electrode 12c and a portion other than the end of the separator 12d.

The first sealing area 14a and the second sealing area 14b may be compressed (or bonded) at the same time by heat and pressure through the sealing tool 20 so as to be sealed.

The sealing may be performed by heat and pressure through the sealing tool 20 so that the adhesion of the second sealing area 14b may correspond to the adhesion of the first sealing area 14a.

FIG. 6 illustrates a plurality of sealing areas of a battery cell of a pouch type secondary battery according to an embodiment of the present invention. FIG. 6 illustrates a configuration of a battery cell 10 when viewed from an upper side.

The battery cell 10 may include an electrode assembly 12, a pouch 11 in which the electrode assembly 12 is accommodated, and an electrode lead 13 electrically connected to the electrode assembly 12.

A first sealing area 14a may be disposed on an area corresponding to an edge of the pouch 11. The first sealing area 14a may be disposed at the edge of the pouch 11, which corresponds to a direction in which an electrode lead 13 that electrically connects the electrode assembly 12 to the outside is disposed.

A second sealing area 14b may be disposed on an area corresponding to an edge of the electrode assembly 12. The second sealing area 14b may be disposed on an area corresponding to the edge of the electrode assembly 12, which corresponds to a direction in which the electrode lead 13 is disposed.

The second sealing area 14b may have a shape corresponding to the shape of an edge at one side of the electrode assembly 12.

The second sealing area 14b may include an area corresponding to the edge of the electrode assembly 12 and a portion of an exterior material area of the pouch 11. In other words, the second sealing area 14b may include ab area overlapping the electrode assembly 12 when viewed from an upper side. The second sealing area 14b may have an area value that is 7% to 14% of an area value of the pouch 11 when viewed from an upper side.

The area of the second sealing area 14b may be greater than the area of the first sealing area 14a.

The adhesion of the second sealing area 14b may correspond to the adhesion of the first sealing area 14a.

The sealing may be performed on a plurality of areas (e.g., the first sealing area 14a and the second sealing area 14b) so that the adhesion of the edge of the pouch 11 of the battery cell 10 may be improved, and also the adhesion between the end of the electrode 12c and the end of the separator 12d of the electrode assembly 12 may be improved.

Although the present invention has been described with reference to the limited embodiments and drawings, the present invention is not limited thereto and may be variously implemented by those of ordinary skill in the art to which the present invention pertains, within the technical idea of the present invention and an equivalent of the appended claims.

1. A secondary battery comprising:
an electrode assembly in which electrodes and a separator are alternately stacked; and
a pouch in which the electrode assembly is accommodated and of which a portion comprises a sealing part that is a bonded portion,
wherein the sealing part comprises
first sealing area spaced a predetermined distance from the electrode assembly and disposed at an edge of the pouch, and
a second sealing area that is provided at an area corresponding to the electrode assembly.

2. The secondary battery of claim 1, wherein the second sealing area is provided at an area corresponding to an edge of the electrode assembly,
wherein the edge of the electrode assembly corresponds to an end of each of the electrodes and an end of the separator.

3. The secondary battery of claim 1, wherein the first sealing area is provided at an area corresponding to a bonding area at the edge of the pouch, and
the second sealing area is provided at an area corresponding to bonding areas at an end of the electrode and an end of the separator.

4. The secondary battery of claim 1, wherein adhesion between an end of the electrode and an end of the separator, which correspond to the electrode assembly, is greater than adhesion between a portion other than the end of the electrode and a portion other than the end of the separator.

5. The secondary battery of claim 1, wherein adhesion of the second sealing area corresponds to adhesion of the first sealing area.

6. The secondary battery of claim 1, wherein the second sealing area is 7% to 14% of an area of the pouch when viewed from an upper side.

7. The secondary battery of claim 1, wherein the first sealing area and the second sealing area are areas bonded and sealed by heat and pressure.

8. The secondary battery of claim 1, wherein an area of the second sealing area is greater than an area of the first sealing area.

9. The secondary battery of claim 1, wherein the second sealing area comprises an area overlapping the electrode assembly when viewed from an upper side.

10. A device for sealing a secondary battery, the device comprising:
a jig configured to receive a pouch in which an electrode assembly is accommodated; and
a sealing tool configured to seal a first sealing area disposed at an edge of the pouch, and configured to seal a second sealing area disposed in an area corresponding to the electrode assembly of the pouch,
wherein the sealing tool performs the sealing of the first sealing area and the second sealing area by heat and pressure.

11. The device of claim 10, wherein the sealing tool comprises an upper block and a lower block,
wherein the upper block comprises a first upper block and a second upper block, and the lower block comprises a first lower block and a second lower block,
wherein the first upper block of the upper block and the first lower block of the lower block are disposed on areas corresponding to each other, and
wherein the first upper block and the first lower block perform the sealing of the first sealing area.

12. The device of claim 11, wherein the second upper block of the upper block and the second lower block of the lower block are disposed in areas corresponding to each other,
wherein the second upper block and the second lower block perform the sealing of the second sealing area while pressing a portion of the electrode assembly.

13. The device of claim 11, wherein, in the sealing tool, the first upper block and the second upper block are integral.

14. A method for sealing a secondary battery, the method comprising:
a disposing process of disposing, on a jig, the secondary battery including a pouch in which an electrode assembly is accommodated; and
a sealing process of sealing a first sealing area disposed at an edge of the pouch disposed on the jig, and a second sealing area corresponding to the electrode assembly of the pouch, by using a sealing tool.

15. The method of claim 14, wherein the sealing process further comprises a sealing process performed so that adhesion between an end of the electrode and an end of the separator, which correspond to the electrode assembly, is greater than adhesion between a portion other than the end of the electrode and a portion other than the end of the separator.

16. The method of claim 14, wherein the sealing process further comprises a sealing process performed so that adhesion of the second sealing area corresponds to adhesion of the first sealing area.

17. The method of claim 14, wherein the sealing process further comprises sealing the first sealing area and the second sealing area at the same time by using the sealing tool.
